(19) United States
(12) Patent Application Publication
(10) Pub. No.: US 2008/0256801 A1
(43) Pub. Date: Oct. 23, 2008

(54) Razor cartridge with front pivot axis

(76) Inventors: William Thomas O'Connor, Londonderry, NH (US); John Prudden, Essex, MA (US); William Earle Tucker, Attleboro, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/788,538

(22) Filed: Apr. 20, 2007

(51) Int. Cl. B26B 21/54

(52) U.S. Cl. 30/50

(57) ABSTRACT

A razor cartridge for connecting to a handle is provided. The razor cartridge includes a blade unit and a frame secured to and surrounding the blade unit. The blade unit includes a plurality of blades. The blades extend along respective parallel blade axes. The frame has a frame perimeter and a pivoting structure. The frame perimeter defines a razor cartridge perimeter for the razor cartridge. The pivoting structure defines a pivot axis for pivoting the razor cartridge with respect to the handle. The pivot axis is located within the frame and in front of the blade axes.

### FIELD OF THE INVENTION

The present invention is directed to a razor cartridge and more particularly to a razor cartridge constructed of a blade unit and a frame secured to the blade unit.

### BACKGROUND OF THE INVENTION

Razor cartridges are designed to cut or shave a user's hair. The cartridges include one or more blades having at least one sharpened edge. The blades are held in place by what is commonly referred to as a housing. The housing typically includes one or more features to improve the overall shaving experience. Such common features include a guard which is located on the housing in front of the blades and a cap which is located behind the blades. The guard often includes an elastomeric member and the cap often includes a lubricating strip of some kind.

On the market today are a vast number of razor cartridge configurations. Some have big guards, some have smaller guards, some guards have elastomeric members with fins while others have elastomeric members with depressions and some guards have lubricating strips. Similarly some razor cartridges have big caps, some have smaller caps, and some caps have a lubricating strip.

In order to meet the demands of consumers, numerous designs have been configured. The numerous designs come at a cost however as much effort is spent on each design. That is, each cartridge is designed from scratch such that none of the molds and production equipment used to make one cartridge can be utilized to make a cartridge of a different design. For example, the molds and production equipment used to make the Gillette™ Mach3™ razor cartridge could not be used to make the Gillette™ Fusion™ razor cartridge. This results in higher cost as product design, molding and production equipment has to be executed separately for each product. Thus, there is a need for an alternative design to reduce cost and effort to produce different razor cartridges to meet the demands of consumers.

Ideally, one would like to start with a standard blade unit that houses the blades. One could then have the flexibility to add frames of various configurations to the standard blade unit. To keep the blade unit in its simplest form the pivot portion of the cartridge should be part of the frame and not part of the blade unit.

### SUMMARY OF THE INVENTION

In accordance with the present invention a razor cartridge for connecting to a handle is provided. The razor cartridge comprises a frame secured to and surrounding a blade unit. The blade unit comprises a plurality of blades. The blades extend along respective parallel blade axes. The frame has a frame perimeter and a pivoting structure. The frame perimeter defines a razor cartridge perimeter for the razor cartridge. The pivoting structure defines a pivot axis for pivoting the razor cartridge with respect to the handle. The pivot axis is located within the frame and in front of the blade axes.

The perimeter comprises a front surface, an opposing rear surface and a pair of side surfaces extending from the front surface to the rear surface. The cartridge comprises a front portion extending from the pivot axis to the front surface and a rear portion extending from the pivot axis to the rear surface. Preferably, the front portion is less than or smaller in dimension than the rear portion.

In accordance with another aspect of the present invention a razor cartridge for connecting to a handle is provided. The razor cartridge comprises a frame secured to and surrounding a blade unit. The blade unit comprises a plurality of blades secured to the blade unit. The blades extend along respective parallel blade axes. The frame has a frame perimeter and a pivoting structure. The frame perimeter defines a razor cartridge perimeter for the razor cartridge. The pivoting structure defines a pivot axis for pivoting the razor cartridge with respect to the handle. The pivot axis is located within the frame and in front of the blade axes.

In accordance with another aspect of the present invention a razor cartridge for connecting to a handle is provided. The razor cartridge comprises a frame secured to and surrounding a blade unit. The blade unit comprises a plurality of blades secured to the blade unit. The blades extend along respective parallel blade axes. The frame has a frame perimeter, an upper surface, a lower surface and a pivoting structure. The frame perimeter defines a razor cartridge perimeter for the razor cartridge. The pivoting structure defines a pivot axis for pivoting the razor cartridge with respect to the handle. The pivot axis is located within the frame, in front of the blade axes, below the upper surface and above the lower surface.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a top plan view of a razor cartridge of the present invention.

FIG. 2 is a bottom plan view of the razor cartridge of FIG. 1.

FIG. 3 is a top plan view of the blade unit of FIG. 1 shown without the frame.

FIG. 4 is a perspective view of the blade unit of FIG. 3.

FIG. 5 is a bottom plan view of the frame of FIG. 1 shown without the blade unit.

FIG. 6 is a perspective view of the frame of FIG. 5.

FIG. 7 is a top plan view of another razor cartridge of the present invention.

### DETAILED DESCRIPTION OF THE INVENTION

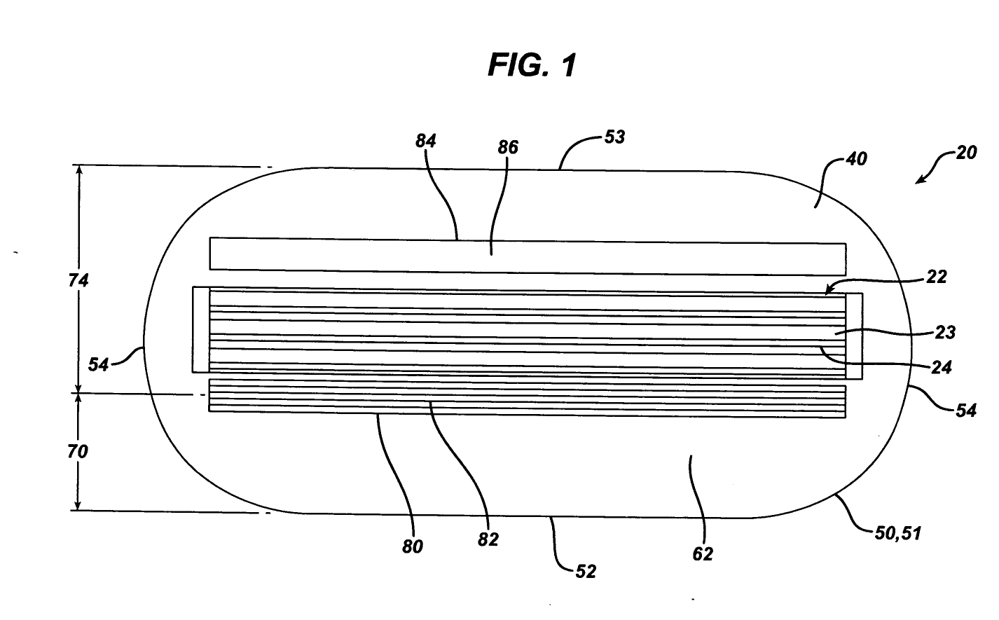

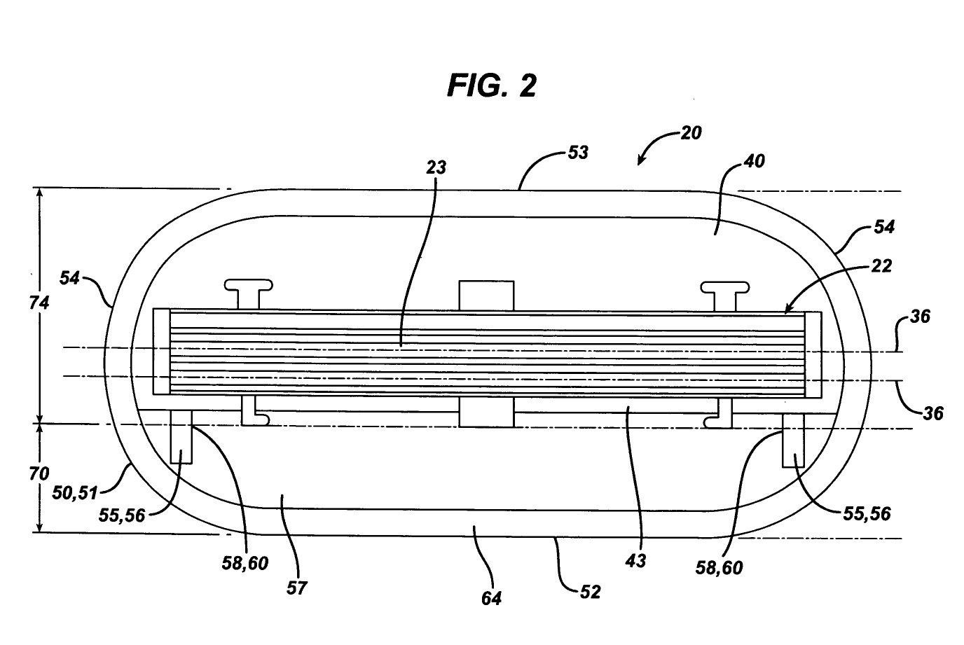

Referring now to FIGS. 1-2, there is shown a razor cartridge 20. The razor cartridge 20 comprises a blade unit 22 and a frame 40 secured to and surrounding the blade unit 22. The blade unit 22 comprises a plurality of blades 23 each comprising a blade edge 24.

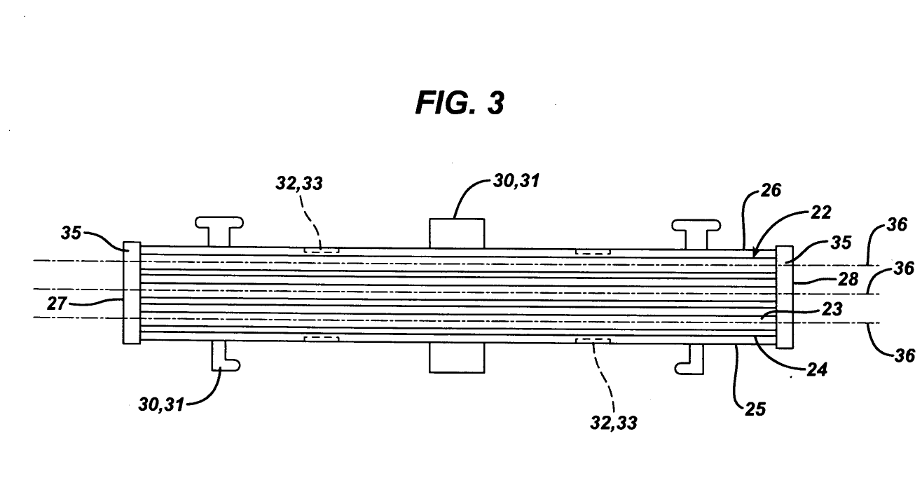

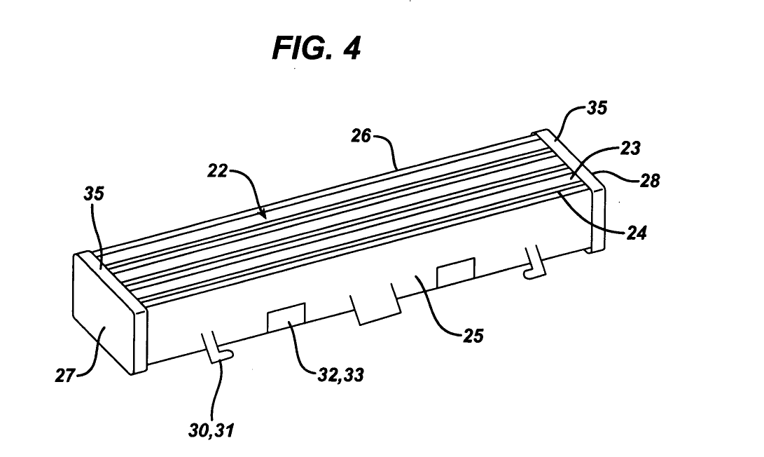

Referring now to FIGS. 3-4, the blade unit 22 is provided with first side wall 25, second side wall 26, and end walls 27 and 28 interconnecting the first side wall 25 and the second side wall 26. The first side wall 25 and the second side wall 26 are provided with first connection members 30 and second connection members 32. Preferably, first connection members 30 comprise projections 31 extending outwardly from each of first and second side walls 25 and 26. Preferably, second connections members 32 comprise recesses 33 in each of the first and second side walls 25 and 26.

Blades 23 are secured within blade unit 22 by a pair of clips 35. Each clip 35 is positioned at an end of blade unit 22 adjacent to end walls 27 and 28. Blades 23 are secured within blade unit 22 by clips 35 such that blade edges 24 contact the bottom surface of clips 35. Blades 23 extend along respective parallel blade axes 36.

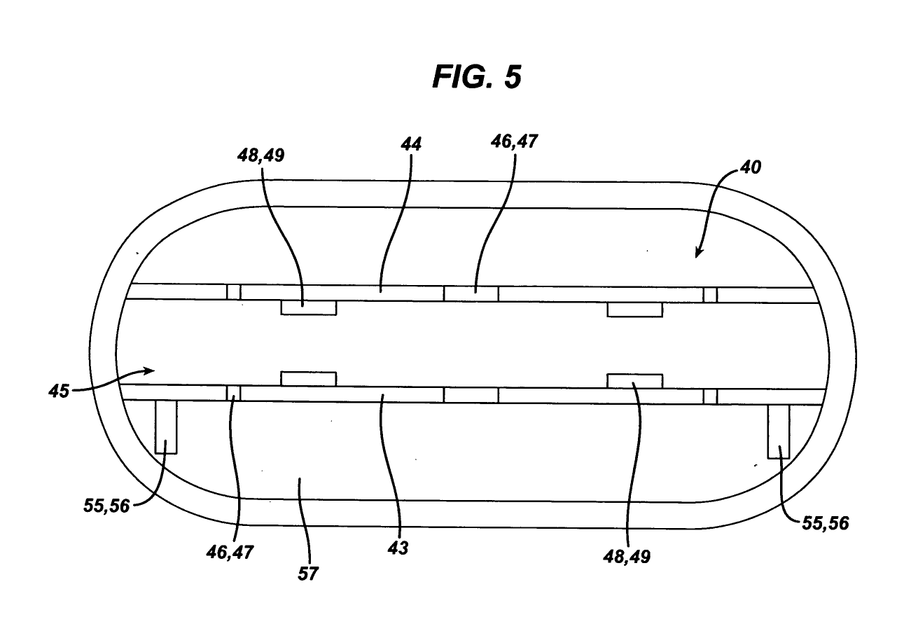

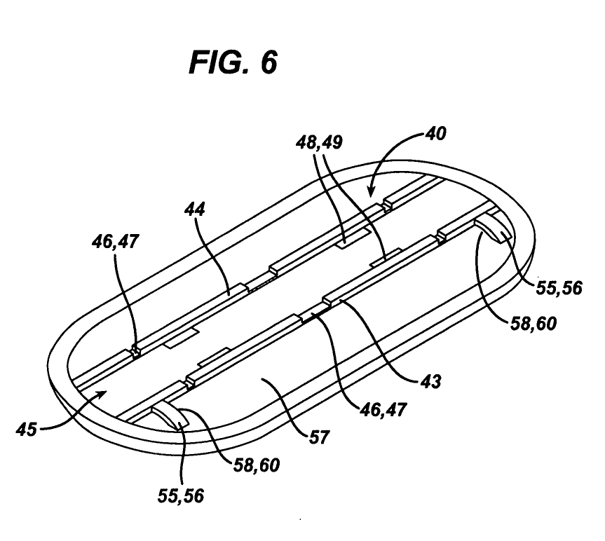

Referring now to FIGS. 5-6, frame 40 is provided with a first interior wall 43 and a second interior wall 44 spaced apart from first interior wall 43 to define an opening 45. Opening 45 is sized and shaped to receive blade unit 22. The first interior wall 43 and the second interior wall 44 are provided with first connection members 46 and second connection members 48. Preferably, first connection members 46 comprise notches 47 in each of the first and second interior walls 43 and 44. Preferably, the second connection members 48 comprise projections 49 extending outwardly from each of the first and second interior walls into opening 45.

First connection members 46 on interior walls 43 and 44 are adapted to receive first connection members 30 on side walls 25 and 26. Second connection members 48 on interior walls 43 and 44 are adapted to receive second connection members 32 on side walls 25 and 26. In securing the frame 40 to the blade unit 20 the projections 31 slide into notches 47 and projections 49 snap into recesses 33.

Referring now to FIGS. 1 and 2 frame 40 has a perimeter 50. Perimeter 50 of frame 40 defines a razor cartridge perimeter 51 for razor cartridge 20. Perimeter 50 comprises a front surface 52, a rear surface 53 and a pair of side surfaces 54 extending from front surface 52 to rear surface 53. Frame 40 also has an upper surface 62 and an opposing lower surface 64.

Referring now to FIGS. 2, 5 and 6, at each end of frame 40 there is a pivoting structure 55. Pivoting structure 55 includes an arm 56 extending from interior surface 57 of frame 40 to first interior wall 43 to define a recess 58. Recess 58 of pivoting structure 55 defines the pivot axis 60 for the razor cartridge 20.

Pivot axis 60 is located within frame 40, below upper surface 62, above lower surface 64, and in front of the blade axes 36. The pivot axis 60 divides the razor cartridge 20 into a front portion 70 and a rear portion 74. Front portion 70 extends from pivot axis 60 to front surface 52. Rear portion 74 extends from pivot axis 60 to rear surface 53. Preferably, the front portion is less than the rear portion. Preferably, the front portion 70 extends from the pivot axis 60 to the front surface 52 by a distance from about 6 mm to about 12 mm. Preferably, the rear portion 74 extends from the pivot axis 60 to the rear surface 53 by a distance from about 15 mm to about 20 mm.

Referring now to FIG. 1, the front portion 70 of upper surface 62 includes guard 80. Guard 80 is that portion of upper surface 62 of frame 40 that contacts the skin prior to or before blade edges 23. Guard 80 preferably comprises an elastomeric member 82.

The rear portion 74 of upper surface 62 includes a cap 84. Cap 84 is that portion of upper surface 62 of frame 40 that contacts the skin after blade edges 23. Cap 84 preferably comprises a lubrication member 86.

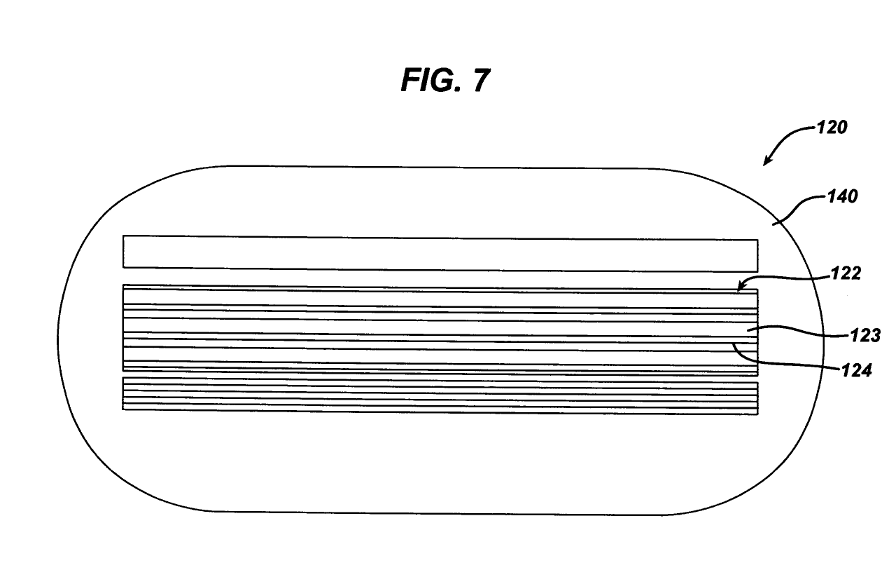

Referring now to FIG. 7, there is shown a razor cartridge 120. The razor cartridge 120 comprises a blade unit 122 and a frame 140 secured to and surrounding the blade unit 122. The blade unit 122 comprises a plurality of blades 123 each comprising a blade edge 124. Razor cartridge 120 is identical to razor cartridge 20 of FIG. 1, except that no clips are used to secure blades 123 within blade unit 122. Instead, a portion of frame 140 extends over each end of blade unit 122 to maintain blades 123 within blade unit 122. A partial cut-away of one end of frame 140 in FIG. 7 reveals the underlying blades 123 within blade unit 122.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge for connection to a handle, the razor cartridge comprising:
a blade unit comprising a plurality of blades, said blades extending along respective parallel blade axes; and
a frame secured to and surrounding said blade unit, said frame having a frame perimeter and a pivoting structure, said frame perimeter defining a razor cartridge perimeter for said razor cartridge, said pivoting structure defining a pivot axis for pivoting the razor cartridge with respect to the handle, said pivot axis being located within said frame and in front of said blade axes.

2. The razor cartridge of claim 1 wherein said perimeter comprises a front surface, an opposing rear surface and a pair of side surfaces extending from said front surface to said rear surface.

3. The razor cartridge of claim 2 further comprising a front portion extending from said pivot axis to said front surface and a rear portion extending from said pivot axis to said rear surface.

4. The razor cartridge of claim 3 wherein said front portion extends from said pivot axis to said front surface by a distance from about 6 mm to about 12 mm.

5. The razor cartridge of claim 3 wherein said rear portion extends from said pivot axis to said rear surface by a distance from about 15 mm to about 20 mm.

6. The razor cartridge of claim 3 wherein said front portion is less than said rear portion.

7. The razor cartridge of claim 3 wherein said front portion comprises an elastomeric member.

8. The razor cartridge of claim 3 wherein said rear portion comprises a lubrication member.

9. A razor cartridge for connection to a handle, the razor cartridge comprising:
a blade unit comprising a plurality of blades secured to said blade unit, said blades extending along respective parallel blade axes; and
a frame secured to and surrounding said blade unit, said frame having a frame perimeter and a pivoting structure, said frame perimeter defining a razor cartridge perimeter for said razor cartridge, said pivoting structure defining a pivot axis for pivoting the razor cartridge with respect to the handle, said pivot axis being located within said frame and in front of said blade axes.

10. The razor cartridge of claim 9 wherein said perimeter comprises a front surface, an opposing rear surface and a pair of side surfaces extending from said front surface to said rear surface.

11. The razor cartridge of claim 10 further comprising a front portion extending from said pivot axis to said front surface and a rear portion extending from said pivot axis to said rear surface.

12. The razor cartridge of claim 11 wherein said front portion is less than said rear portion.

13. The razor cartridge of claim 11 wherein said front portion comprises an elastomeric member.

14. The razor cartridge of claim 11 wherein said rear portion comprises a lubrication member.

15. A razor cartridge for connection to a handle, the razor cartridge comprising:
a blade unit comprising a plurality of blades secured to said blade unit, said blades extending along respective parallel blade axes; and
a frame secured to and surrounding said blade unit, said frame having a frame perimeter, an upper surface, a lower surface and a pivoting structure, said frame perimeter comprising a front surface, an opposing rear surface and a pair of side surfaces extending from said front surface to said rear surface defining a razor cartridge perimeter for said razor cartridge, said pivoting structure defining a pivot axis for pivoting the razor cartridge with respect to the handle, said pivot axis being located in front of said blade axes, below said upper surface and above said lower surface.
